(19) United States
(12) Patent Application Publication
(10) Pub. No.: US 2022/0307603 A1
(43) Pub. Date: Sep. 29, 2022

(54) NON-CONTACT SEAL ASSEMBLY WITH DAMPING ELEMENTS

(71) Applicant: SIEMENS ENERGY GLOBAL GMBH & CO. KG, München (DE)

(72) Inventors: Anil L. Salunkhe, Charlotte, NC (US); Amit K. Paspulati, Charlotte, NC (US); William J. Curtin, Fort Mill, SC (US)

(21) Appl. No.: 17/597,151

(22) PCT Filed: Jul. 30, 2019
(86) PCT No.: PCT/US2019/044139

§ 371 Date: Dec. 28, 2021

(51) Int. Cl. F16J 15/44

(52) U.S. Cl. CPC F16J 15/442; F16J 15/445

(57) ABSTRACT

A non-contact seal assembly for sealing a circumferential gap between a first machine component and a second machine component which is rotatable relative to the first machine component about a longitudinal axis is provided. The non-contact seal assembly includes a seal carrier, a primary seal that includes a plurality of shoes, a mid plate, a secondary seal, and a front plate. The secondary seal may comprise a plurality of sealing segments. The non-contact seal also includes a plurality of damping elements to damp vibrations of the primary seal during operation.

### BACKGROUND

### 1. Field

The present disclosure relates generally to a seal assembly and, more particularly, to a non-contact seal assembly for sealing a circumferential gap between two machine components that are rotatable with respect to each other.

### 2. Description of the Related Art

Turbomachinery, such as gas turbine engines, currently is dependent on either labyrinth, brush or carbon seals for critical applications. Labyrinth seals provide adequate sealing, but they are extremely dependent on maintaining radial tolerances at all points of engine operation. The radial clearance must take into account factors such as thermal expansion, shaft motion, tolerance stack-ups, rub tolerance, etc. Minimization of seal clearance is necessary to achieve maximum labyrinth seal effectiveness. In addition to increased leakage if clearances are not maintained, there is potential for increases in engine vibration. Brush seals may be used in a wide variety of applications. Although brush seal leakage generally decreases with exposure to repeated pressure loading, incorporating brush seals where extreme pressure loading occurs may cause a ‘blow over’ condition resulting in permanent deformation of the seal wires. Carbon seals are generally used to provide sealing of oil compartments and to protect oil systems from hot air and contamination. In comparison to labyrinth or brush seals, carbon seals have low leakage rates, however, they are very sensitive to pressure balances and tolerance stack ups.

Turbomachinery, such as gas turbines engines, are becoming larger, more efficient, and more robust. Large blades and vanes are being utilized, especially in the hot section of the engine system. In view of high pressure ratios and high engine firing temperatures implemented in modern engines, certain components, such as airfoils, e.g., stationary vanes and rotating blades, require more efficient sealing capabilities than the ones that exist currently.

The compressor and turbine sections of some types of turbomachinery, such as gas turbine engines, may include several locations in which there may be gaps, or clearances, between the rotating and stationary components. During engine operation, system loss may occur by fluid leakage through clearances in the compressor and turbine sections. This system loss decreases the operational efficiency of the system. An example of the flow leakage is across a clearance between the tips of rotating blades and a surrounding stationary structure of boundary, such as an outer shroud or a vane carrier.

Both labyrinth and brush seals have been utilized between the rotating and stationary components in turbines, however, both types of seals contact the rotor and thus degrade over time, allowing losses due to flow leakage and eventually requiring replacement. Thus, non-contacting seals for sealing circumferential gaps between rotating and stationary components in turbines are desired.

### SUMMARY

Briefly described, aspects of the present disclosure relate to a non-contact seal assembly for sealing a circumferential gap between a first machine component and a second machine component which is rotatable relative to the first machine component about a longitudinal axis in the axial direction and to a seal damping system to minimize vibration for a non-contact seal assembly.

An aspect provides a seal assembly includes a seal carrier, a primary seal, a secondary seal, a mid-plate, a front plate, and at least one damping element. The primary seal includes at least one shoe extending along one of the first and second machine components producing a non-contact seal therewith, the shoe being formed within a slot and at least one spring element comprising a plurality of seal beams adapted to connect to one of the first and second machine components, and being connected to the at least one shoe, the at least one spring element being effective to deflect and move with the at least one shoe in response to fluid pressure applied to the at least one shoe by a fluid stream to assist in the creation of a primary seal of the circumferential gap between the first and second machine components. The secondary seal includes a sealing element, the sealing element comprising a plurality of sealing segments arranged circumferentially, each segment oriented side by side in a circumferential direction so that a gap exists between the edges of two adjoining segments. The front plate is adjacent to the sealing element of the secondary seal and extending into the slot formed in the at least one shoe. The at least one damping element damps vibrations of the seal beams during operation.

These and other features, aspects, and advantages of the present invention will become better understood with reference to the following drawings, description, and claims.

### BRIEF DESCRIPTION OF THE DRAWINGS

FIG. 1 is an exploded view of an exemplary embodiment of a non-contact seal assembly,

FIG. 2 is an end view of a portion of an exemplary embodiment of the non-contact seal assembly,

FIG. 3 is an elevational view of a portion of an exemplary embodiment of a secondary seal of a non-contact seal assembly,

FIG. 4 is an enlarged perspective view of the ends of adjacent segments of the secondary seal of FIG. 3,

FIG. 5 is an end view of an exemplary embodiment of a portion of the non-contact seal assembly showing two sealing elements of the secondary seal,

FIG. 6 is an elevational view of a portion of an exemplary embodiment of a primary seal of a non-contact seal assembly,

FIG. 7 is an elevational view of a portion of an exemplary embodiment of the non-contact seal including damping elements,

FIG. 8 is an elevational view of a portion of an exemplary embodiment of the non-contact seal including damping elements,

FIG. 9 is an elevational view of a portion of an exemplary embodiment of the non-contact seal including damping elements, and

FIG. 10 is an elevational view of a portion of an exemplary embodiment of the non-contact seal including an axial slot for receiving a damping element, and

FIG. 11 is an elevational view of a portion of an exemplary embodiment of the non-contact seal including a radial slot for receiving a damping element.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

Non-contact seals have been previously developed and comprise an assembly of moving parts. In one embodiment, a non-contact seal is positioned between a stationary component, such as a stator, and a rotating component, such as a rotor. The seal may attach to the stator leaving a gap, or clearance, between the rotor and stator. In operation, the seal positions itself very close to the rotor without contacting the rotor, for example, less than or equal to 0.8 mm, due to a pressure gradient formed between the forward end and the aft end of the seal. The non-contact seal thus provides sufficient sealing between the stationary component and the rotating component.

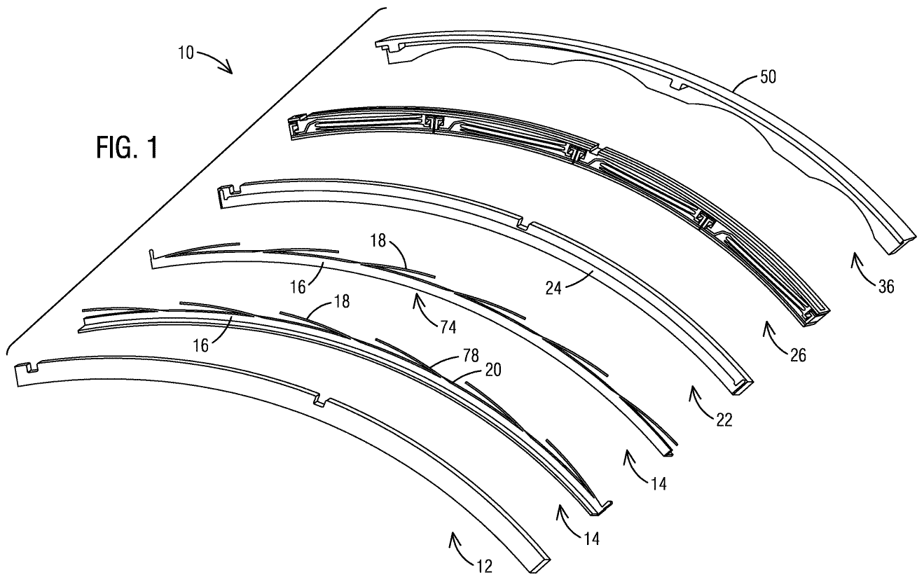

Referring now to FIG. 1, FIG. 1 shows an exploded view of an embodiment of a non-contact seal assembly 10 that may be included in turbomachinery, such as a gas turbine. The seal assembly 10 includes a seal carrier 36, the seal carrier 36 including an outer surface or outer ring 50, a primary seal 26, a mid-plate 22, a secondary seal 14 that may include a plurality of circumferentially spaced sealing elements 16, and a front plate 12.

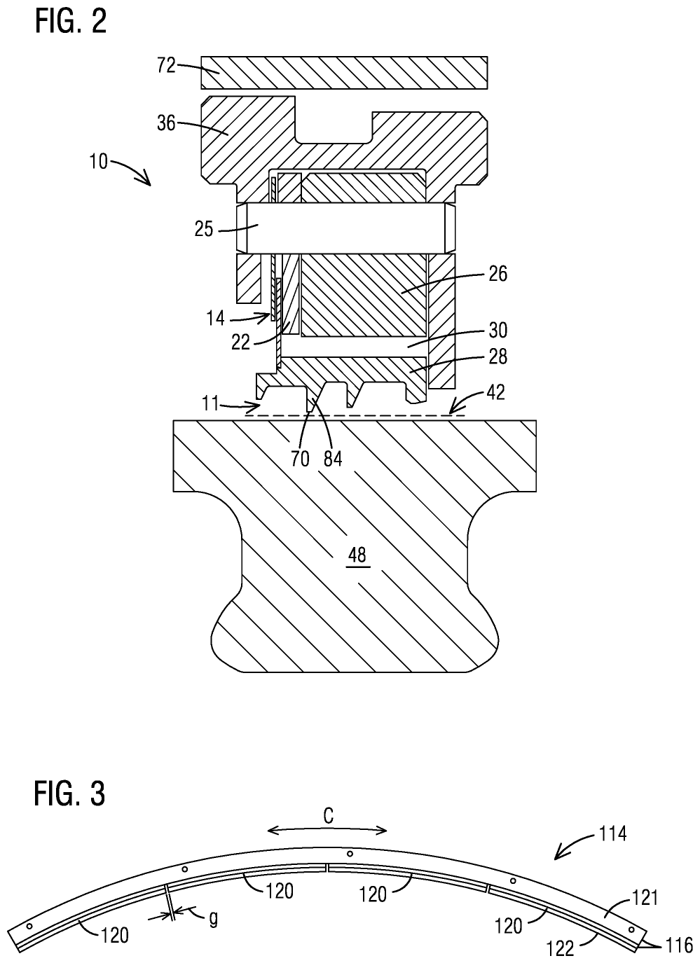

Referring now to FIG. 2, FIG. 2 shows the non-contact seal assembly 10 in its assembled form. The seal assembly 10 may include, at least one secondary seal 14, a mid-plate 22, a primary seal 26, and a seal carrier 36. The assembled seal assembly 10 creates a non-contact seal of a circumferential gap 11 between two components, a first machine component and a second machine component, such as a fixed stator 72 and a rotating rotor 48. Each seal assembly 10 includes at least one, and in some situations, a plurality of circumferentially spaced shoes 28 that are located in a non-contact position along an exterior surface of the rotor 48, as part of the primary seal 26. Each shoe 28 has a sealing surface 70 and a slot 30 that extends radially inward toward the sealing surface 70 as can be seen in FIG. 2. The at least one shoe 28 is formed with two or more projections 84, or fins, relative to one of the machine components, and is the bottom portion of the primary seal 26, as can be seen in FIG. 2. For purposes of this discussion, the term ‘axial’ or ‘axially spaced’ refers to a direction along the longitudinal axis 42 of the stator 72 and rotor 48, whereas ‘radial’ refers to a direction perpendicular to the longitudinal axis 42.

One of the moving parts of the non-contact seal assembly 10 is the secondary seal 14. The secondary seal 14 of the non-contact seal assembly 10 is utilized to separate the forward and aft pressure zones and maintain the pressure differential which allows the non-contact seal 10 to self-adjust its positioning. Additionally, the secondary seal 14 is designed to be very flexible and act as a damping element during seal operation. A previous design of the secondary seal includes damping elements that are prone to High Cycle Fatigue (HCF) failures leading to their cracking. A previous design of the secondary seal 14 may be seen in FIG. 1. This secondary seal design includes at least one sealing element or plate 16 and has at least one spring member 18 positioned radially outward from the plate 16 as shown along an outer ring surface 20. The secondary seal 14 spans continuously across multiple shoes 28 and uses the spring-loaded spring member 18 to seal against the shoes 28 in operation. It has been found, however, that under constant HCF loading these spring members 18 crack at their base 78.

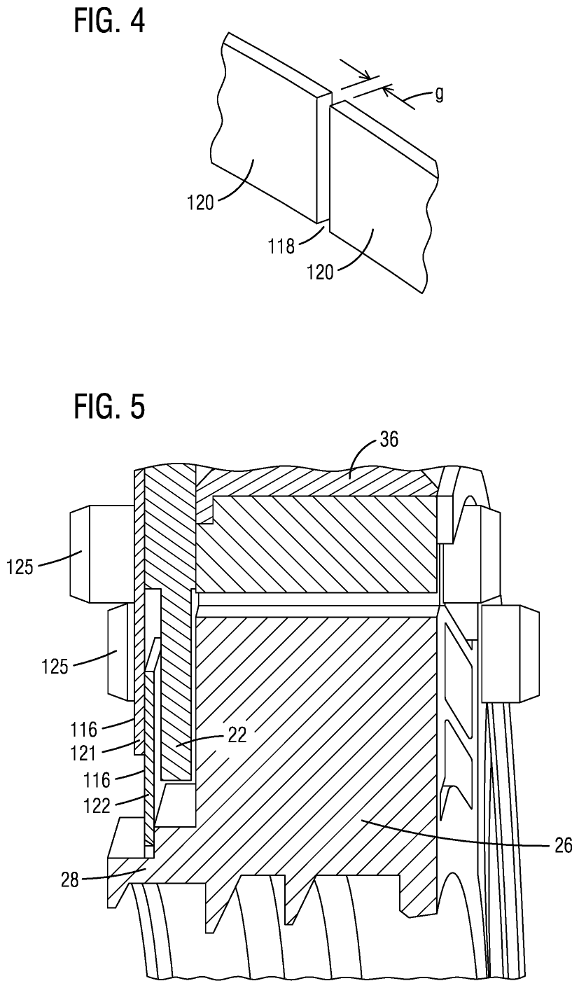

Referring now to FIG. 3, FIG. 3 shows an elevational view of an improved secondary seal 114 according to an embodiment. The secondary seal 114 comprises at least one sealing element 116. In an embodiment, the sealing element includes two sealing elements 116, a forward sealing element and an aft sealing element. The aft sealing element may comprise a plurality of segments 120, arranged side by side in a circumferential direction C so that a small gap (g) exists in between adjacent segments 120 An enlarged view of the ends of the adjacent segments 120 including the gap (g) may be seen as illustrated in FIG. 4. The small gap (g) may include a range between 0 and 1 inch. The gap (g) between each segment may be parallel, or in line to the shoes 28. The plurality of segments 120 may extend into the slot 30 of the least one shoe 28.

In certain embodiments, the secondary seal 14 comprises two sealing elements 116, a forward floating sealing element 121 and an aft fixed sealing element 122. The orientation of two sealing elements 121, 122 of a secondary seal may be seen in FIG. 5 which shows an end view of the non-contact seal assembly 10. The sealing elements 116 may be arranged side by side in the axial direction and at least partially overlap in the radial direction. In an embodiment, the aft sealing element, which is positioned more radially inward than the forward sealing element 121, may be fixed to the shoe of the primary seal 26. Fixing the aft sealing element 122 to the primary seal 26 prevents a fluid flow at the secondary seal routing the flow underneath the shoes which maintains the pressure differential while creating inherent damping to the primary seal movement. Additionally, the secondary seal 114 may move with the seal shoes 28 reducing the wear of the secondary seal 116. The fixing may be accomplished by welding, caulking, or brazing, for example. The floating sealing element 121 may be anchored to the other seal elements utilizing axial pins 25, 125. The axial pins 25, 125 span across the floating secondary seal 121, the mid plate 22, the primary seal 26, and the seal carrier 36. As may be seen in FIG. 3, the floating seal 121 at least partially overlaps the gaps (g) in the aft fixed sealing element 122 in the axial direction thereby separating the forward and aft pressure zones and maintaining the pressure differential in the axial (or fluid flow) direction.

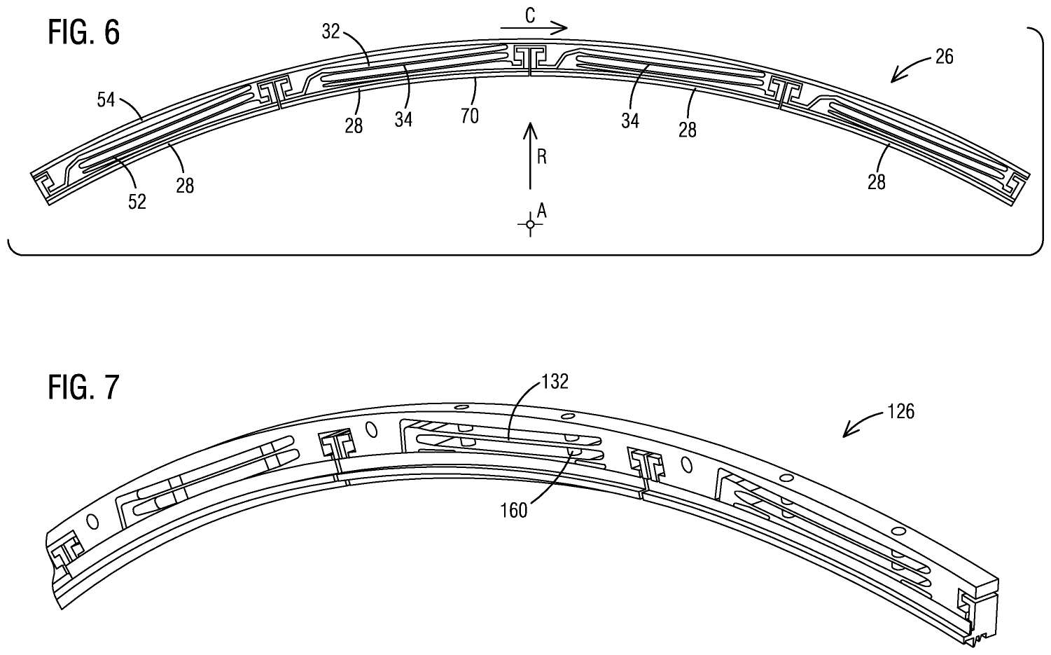

In certain operating conditions, especially at higher pressures, it is desirable to limit the extent of radial movement of the shoes 28 with respect to the rotor 48 to maintain clearances, e.g. the spacing between the shoes 28, and the facing surface of the rotor 48. FIG. 6 illustrates an elevational view of a portion of the primary seal 26. The primary seal 26 may include a number of circumferentially spaced spring elements 34, each spring element 34 comprising at least one seal beam 32. The spring elements 34 deflect, and move with the shoe 28, to create a primary seal of the circumferential gap 11 between the rotor 48 and stator 71, for instance. Each spring element 34 is formed with an inner band 52, and an outer band 54 radially outwardly spaced from the inner band 52. One end of each of the bands 52 and 54 is mounted to, or integrally formed with, the stator 72.

In an embodiment, damping elements may be utilized to dampen the vibrations of the seal beams 32 during turbomachine operation. With reference to the primary seal 126 of FIG. 7, a plurality of damping pins 160 may be disposed to extend radially through respective openings in the seal beams 32. Packaging the damping elements through seal beams 132 reduce the vibratory responses in addition to providing inherent damping to the non-contact seal assembly 10. In an embodiment, the damping pins 160 may comprise elastomers which exhibit viscoelasticity to dampen the vibrations of the seal beams 132. More specifically, in an embodiment, the damping pins 160 may comprise an elastic or a metal.

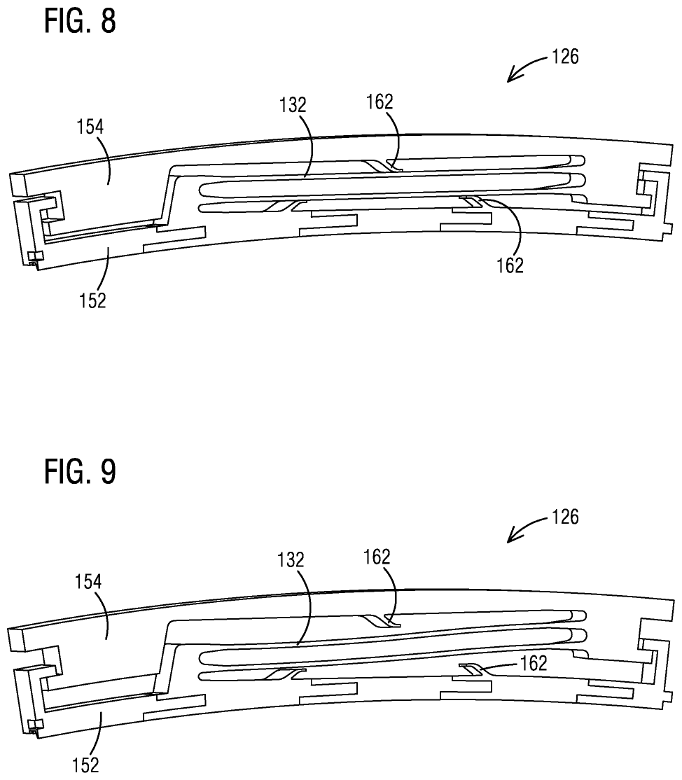

In an alternate embodiment, flexible damping springs may be utilized as damping elements. The flexible damping springs 162, as seen in FIG. 8, extend from the radially inner surface of the outer band 154 and/or from the radially outer surface of the inner band 152 as shown in FIGS. 8 and 9 respectively. The flexible damping springs 162 may be attached to the seal beams 132 as seen in FIG. 8 or unattached to the seal beams 132 as seen in FIG. 9. In an embodiment, the flexible damping springs 162 may comprise metal. More specifically, the flexible damping springs 162 may comprise an alloy material similar to that of the components of non-contact seal assembly 10. Most specifically, in an embodiment, the flexible damping springs 162 comprise the same material, such as INCO718, as the components of the non-contact seal assembly 10.

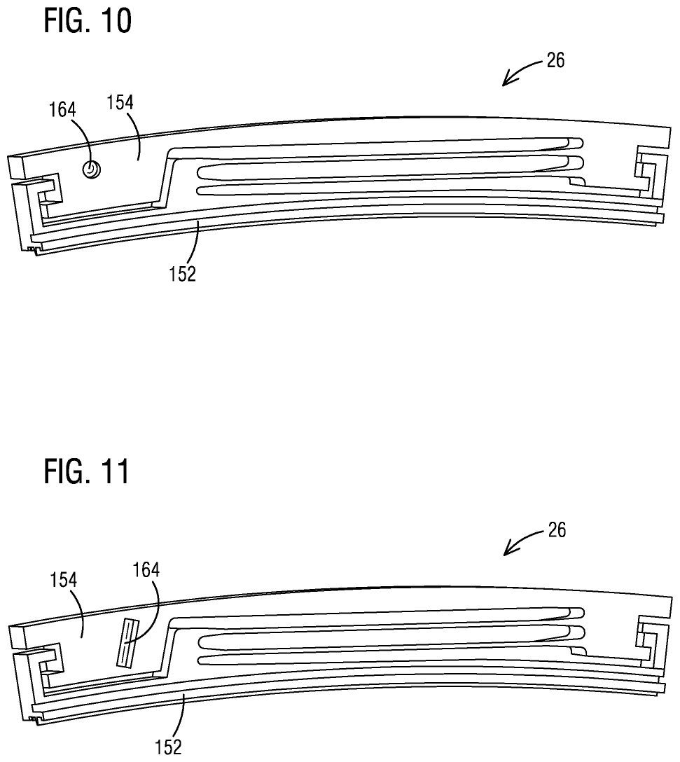

In a further alternate embodiment, damping elements embodied as pins 164 may be inserted in an opening within the outer band 154 of the primary seal 126 as seen in FIGS. 10 and 11. In one embodiment shown in FIG. 10, the damping pin 164 may be positioned in an axial direction. Alternately, as seen in FIG. 11, the damping pin 164 may be positioned to extend radially. The damping pins may comprise an elastic or a metal. In an embodiment, the damping pins 164 comprise steel.

The proposed non-contact seal assembly utilizes damping elements in combination with the secondary seals to dampen vibrations of the seal beams during operation of the turbomachinery. The inventors thus propose a way to isolate the damping functionality from the sealing functionality improving the fatigue life of the non-contact seals. Additionally, the proposed damping elements can prevent the non-contact seal from responding to resonating frequencies and helps the seal withstand the High Cycle Fatigue cycles.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

1. A non-contact seal assembly, comprising:
a seal carrier that holds all components of the seal assembly along an outer ring;
at least one primary seal comprising:
at least one shoe extending along one of the first and second machine components producing a non-contact seal therewith, the shoe being formed within a slot,
at least one spring element comprising a plurality of seal beams adapted to connect to one of the first and second machine components, and being connected to the at least one shoe, the at least one spring element being effective to deflect and move with the at least one shoe in response to fluid pressure applied to the at least one shoe by a fluid stream to assist in the creation of a primary seal of the circumferential gap between the first and second machine components;
a mid-plate extending into the slot formed in the at least one shoe;
a secondary seal comprising a sealing element, the sealing element comprising a plurality of sealing segments arranged circumferentially, each segment oriented side by side in a circumferential direction C so that a gap (g) exists between the edges of two adjoining segments; and
a damping element wherein the damping element damps vibrations of the seal beams during operation.

2. The non-contact seal as claimed in claim 1, wherein the secondary seal comprises two sealing elements oriented side by side in axial direction, a forward sealing element and an aft sealing element, so that the two sealing elements at least partially overlap in a radial direction.

3. The non-contact seal of claim 2, wherein the aft sealing element is fixed to the shoe of the primary seal.

4. The non-contact seal of claim 3, wherein the fixed to the shoe by welding, brazing, or caulking.

5. The non-contact seal of claim 1, wherein the damping element is a flexible spring.

6. The non-contact seal of claim 5, wherein the flexible spring extends from the radially inner surface of the outer band and/or from the radially outer surface of the inner band.

7. The non-contact seal of claim 6, wherein the flexible spring attaches to the seal beam.

8. The non-contact seal of claim 6, wherein the flexible spring does not attach to the seal beam.

9. The non-contact seal of claim 1, wherein the damping element is a damping pin comprising an elastomer utilizing viscoelasticity to dampen the vibrations.

10. The non-contact seal of claim 9, wherein the damping pin extends radially through respective openings in the seal beams.

11. The non-contact seal of claim 1 wherein the damping element is a metallic damping pin.

12. The non-contact seal of claim 11, wherein the metallic damping pin comprises steel.

13. The non-contact seal of claim 11, wherein the metallic damping pin extends radially within an opening in the outer band.

14. The non-contacting seal of claim 11, wherein the metallic damping pin extends axially within an opening in the outer band.

15. A seal damping system to minimize vibration of a non-contact seal assembly, comprising:
a first turbomachine component of a turbomachine;
a second turbomachine component of the turbomachine rotatable relative to the first machine component about a longitudinal axis in the axial direction; and
a non-contact seal assembly as claimed in claim 1 disposed between the first turbomachine component and the second turbomachine component,
wherein the damping element dampens vibrations of the seal beams of the primary seal during operation of the turbomachine.

16. The seal damping system as claimed in claim 15, wherein the secondary seal comprises two sealing elements oriented side by side in axial direction, a forward sealing element and an aft sealing element, so that the two sealing elements at least partially overlap in a radial direction.

17. The seal damping system of claim 16, wherein the aft sealing element is fixed to the shoe of the primary seal.

18. The seal damping system of claim 17, wherein the fixed to the shoe by welding, brazing, or caulking.

19. The seal damping system of claim 15, wherein the damping element is a flexible spring.

20. The seal damping system of claim 15, wherein the flexible spring extends from the radially inner surface of the outer band and/or from the radially outer surface of the inner band.
